(19) United States
(12) Patent Application Publication
(10) Pub. No.: US 2005/0066344 A1
(43) Pub. Date: Mar. 24, 2005

(54) Disk guider for a disk drive to facilitate insertion of an optical disk thereinto

(75) Inventor: Jui-Chiang Lin, Hsinchu City (TW)

Correspondence Address: BIRCH STEWART KOLASCH & BIRCH, PO BOX 747, FALLS CHURCH, VA, 22040-0747, US

(73) Assignee: Lite-On It Corporation, Taipei City (TW)

(21) Appl. No.: 10/941,935

(22) Filed: Sep. 16, 2004

(30) Foreign Application Priority Data
Sep. 19, 2003 (TW) 92126024

(51) Int. Cl. G11B 33/14; G11B 33/02

(52) U.S. Cl. 720/646

(57) ABSTRACT

A disk drive includes a casing having a front wall formed with an entrance-and-exit slot, and a disk guider mounted on the front wall of the casing. The disk guider includes a hollow guider wall having an inner end defining an inner opening aligned with and in spatial communication with the entrance-and-exit slot, and an outer end defining an outer opening which gradually and inwardly converges toward the inner end such that the outer end has a cross-section greater than that of the inner end.

### FIELD OF THE INVENTION

The invention relates to a disk guider, more particularly to a disk guider for a disk drive of slot-in type to facilitate insertion of an optical disk thereinto.

### DESCRIPTION OF THE RELATED ART

An optical disk drive of slot-in type is generally installed in a notebook computer or in an audio-and-video instrument (such as a CD or DVD player) of an automobile for reproducing the information recorded in an optical disk, such as playing songs from a CD. The computer's peripheral devices, such as a printing machine, a DVD player, are also used at homes besides in offices due to its lower cost caused by rapid advance in the manufacture of computer's peripheral devices.

Referring to FIG. 1, a partly perspective view of a conventional disk drive 2 is shown to include a casing 1 having a front wall 11 formed with a disk entrance-and-exit slot 1c, and a disk transport mechanism (not visible) disposed within the casing 1 adjacent to the entrance-and-exit slot 1c for feeding an optical disk 9 into the casing 1 or for ejecting the optical disk 9 from the casing 1. FIGS. 2A, 2B, 3A, 3B, 4A and 4B respectively show perspective and enlarged views of the front walls 11 of the casings 1 used in the conventional disk drives. Note the different designs of the entrance-and-exit slots 1c formed through the front walls 11. The entrance-and-exit slot 1c of FIGS. 2A and 2B has a uniform width along the entire length thereof. The entrance-and-exit slot 1c of FIGS. 3A and 3B has two opposite narrow-width sections and a large-width intermediate section between the narrow-width sections. Alternatively, the entrance-and-exit slot 1c of FIGS. 4A and 4B converges gradually and inwardly from an outer end toward an inner end.

In the event, one of the aforesaid conventional disk drives is employed in the audio-and-video instrument (not shown) of the automobile, the user may encounter the difficulty of inserting an optical disk 9 into the casing 1 via the entrance-and-exit slot 1c due to the limited width of the entrance-and-exit slot 1c. The situation is aggravated when the automobile is in motion, which, in turn, causes the casing 1 to wobble constantly, thereby increasing the difficulties of inserting the optical disk 9 into the casing 1 via the entrance-and-exit slot 1c.

### SUMMARY OF THE INVENTION

The object of the present invention is to provide a disk guider for a disk drive of slot-in type to facilitate insertion of the optical disk into a casing of the disk drive so as to eliminate the aforesaid disadvantage resulting from the use of the conventional disk drive.

A disk guider is provided according to the present invention for an optical disk drive that has a front wall formed with an elongated disk entrance-and-exit slot. The disk guider includes: a hollow guider wall adapted to be mounted on the front wall of the casing, and having an inner end defining an inner opening adapted to be aligned with and in spatial communication with the entrance-and-exit slot, and an outer end defining an outer opening which gradually and inwardly converges toward the inner end such that the outer end has a cross-section greater than that of said inner end; and a fastening member for fastening the disk guider wall on the front wall.

In another aspect of the present invention, a disk drive is provided to have a front wall formed with an entrance-and-exit slot and includes: a hollow guider wall adapted to be mounted on the front wall; and a fastening member for fastening the guider wall on the front wall. Preferably, the hollow guider wall has an inner end defining an inner opening aligned with and in spatial communication with the entrance-and-exit slot, and an outer end defining an outer opening which gradually and inwardly converges toward the inner end such that the outer end has a cross-section greater than that of the inner end.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a perspective view, illustrating how an optical disk is inserted into the entrance-and-exit slot in a casing of a conventional disk drive;

FIGS. 2A and 2B respectively show partly perspective and enlarged views of the front wall of the casing of a conventional disk drive;

FIGS. 3A and 3B respectively show partly perspective and enlarged views of the front wall of the casing of a conventional disk drive;

FIGS. 4A and 4B respectively show partly perspective and enlarged views of the front wall of the casing of a conventional disk drive;

FIG. 5 is a perspective and partly exploded view of the first preferred embodiment of a disk drive according to the present invention;

FIG. 6 is a perspective view, illustrating how an optical disk is inserted into of the first preferred embodiment of the disk drive according to the present invention;

FIG. 7A is a perspective view, illustrating how an optical disk is inserted into of the second preferred embodiment of a disk drive according to the present invention;

FIG. 7B is an enlarged view of a disk guider employed in the second preferred embodiment of the disk drive according to the present invention;

FIG. 8A is a perspective view of the third preferred embodiment of a disk drive according to the present invention;

FIG. 8B is an enlarged view of a disk guider employed in the third preferred embodiment of the disk drive according to the present invention;

FIG. 9 is a perspective and partly exploded view of the fourth preferred embodiment of a disk drive according to the present invention;

FIG. 10 is a perspective and partly exploded view the fifth preferred embodiment of the disk drive according to the present invention;

FIG. 11 is a side view, illustrating how an optical disk is inserted into the conventional disk drive; and

FIG. 12 is a side view, illustrating how an optical disk is inserted into the disk drive of the present invention.

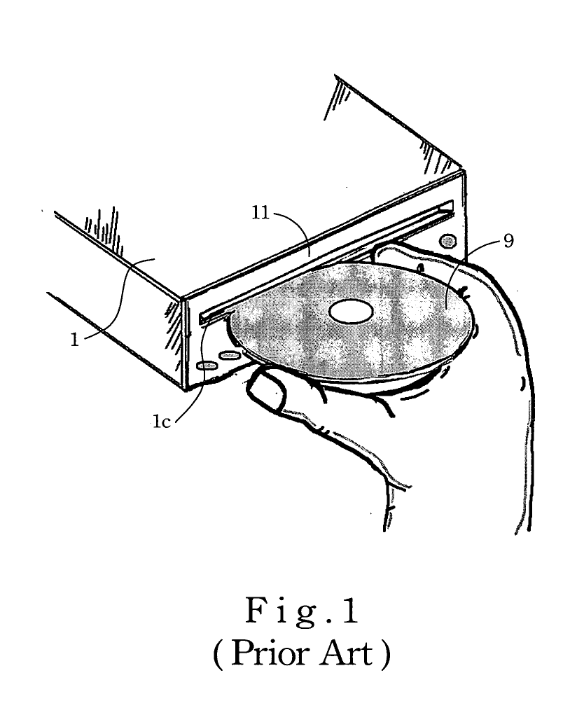

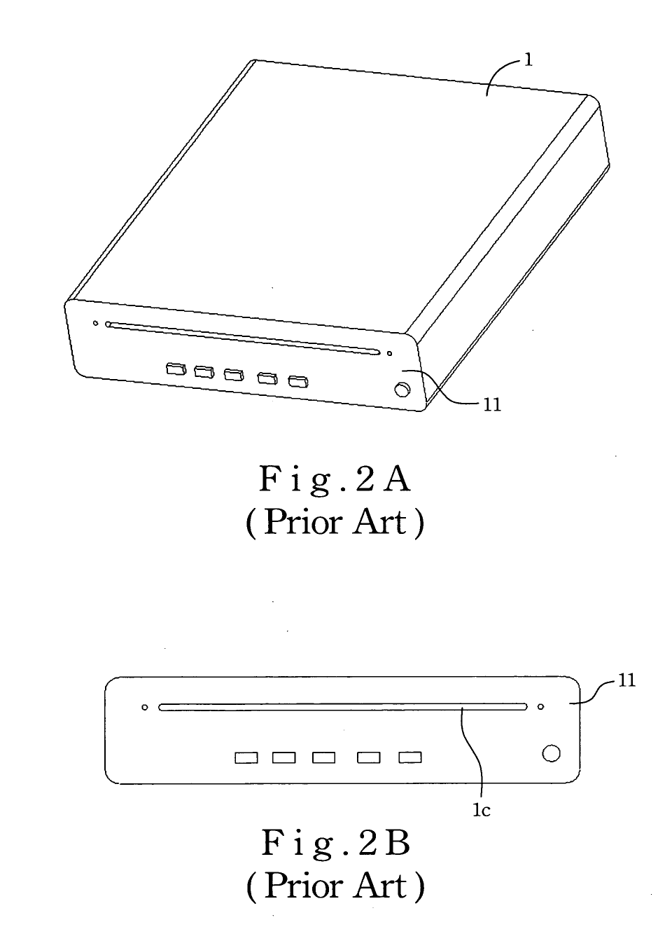

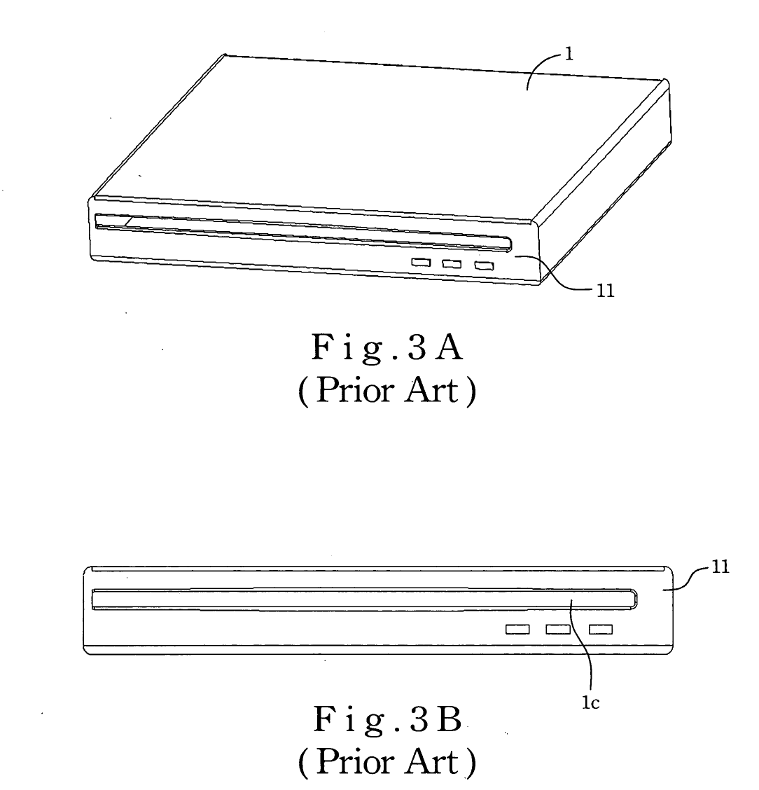

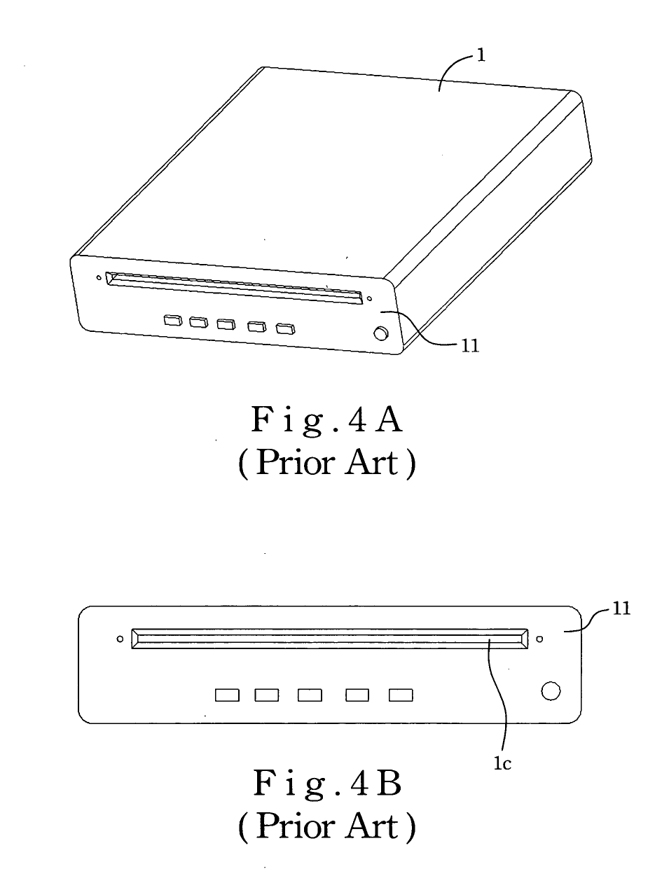

### DETAILED DESCRIPTIONS OF THE PREFERRED EMBODIMENT

It should be noted that same reference numerals have been used to denote similar elements throughout the drawings and the specification.

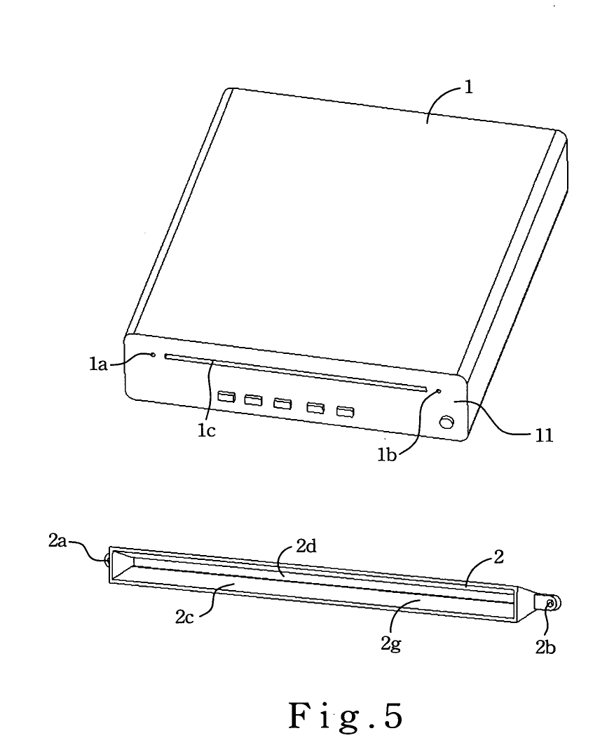

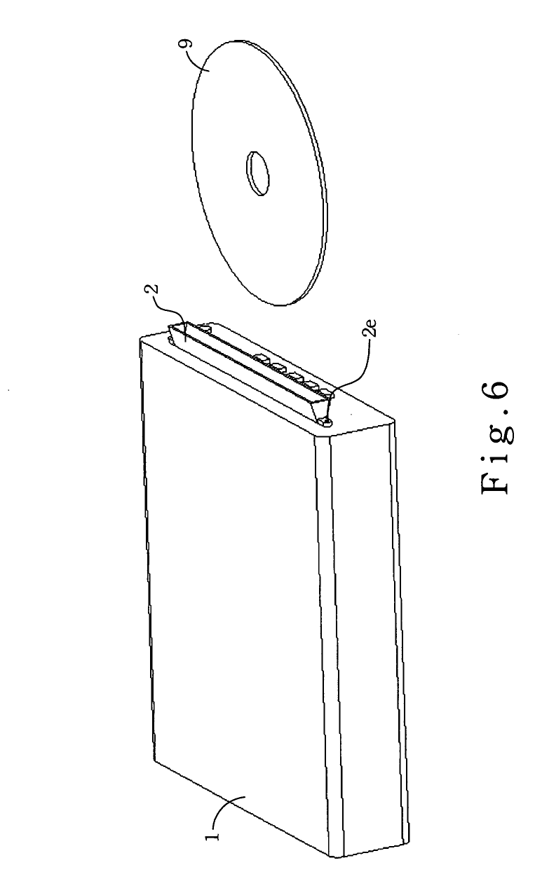

Referring to FIGS. 5 and 6, a perspective and partly exploded view of the first preferred embodiment of a disk drive of slot-in type according to the present invention is shown and is generally installed in a notebook computer (not shown) or in an audio-and-video instrument of an automobile for reproducing the information recorded in an optical disk 9, such as playing songs from a CD.

As illustrated, the first preferred embodiment includes a casing 1 having a front wall 11 formed with an entrance-and-exit slot 1c, a reading and/or writing pick-up head (not visible) disposed within the casing 1 for reading and/or writing the information recorded in the optical disk 9, a disk transport mechanism (not visible) disposed within the casing 1 adjacent to the entrance-and-exit slot 1c, a disk guider 2 fixed detachably on the front wall 11 to facilitate insertion of the disk 9 into the casing 1, and a fastening member. As to how the optical disk 9 is drawn into or ejected from the casing 1 upon activation of the transport mechanism and how the pick-up head reads the optical disk 9 are not the relevant features of the present invention, detailed description of the same are omitted herein for the sake of brevity.

The disk guider 2 is mounted on the front wall 11 of the casing 1, and includes a hollow guider wall 2g. The hollow guider wall 2g has an inner end defining an inner opening 2d aligned with and in spatial communication with the entrance-and-exit slot 1c in the casing 1, and an outer end defining an outer opening 2c which gradually and inwardly converges toward the inner end such that the outer end has a cross-section greater than that of the inner end to facilitate insertion of the disk 9 into the casing 1. The first preferred embodiment further includes two mounting parts 2a, 2b that respectively and outwardly project from two opposite sides of the hollow guider wall 2g and that are respectively formed with a through hole. The fastening member preferably includes two fastener screws 2e (see FIG. 6) extending respectively through the through holes in the mounting parts 2a, 2b for threadedly engaging the holes 1a, 1b in the front wall 11 of the casing 1 (see FIG. 5).

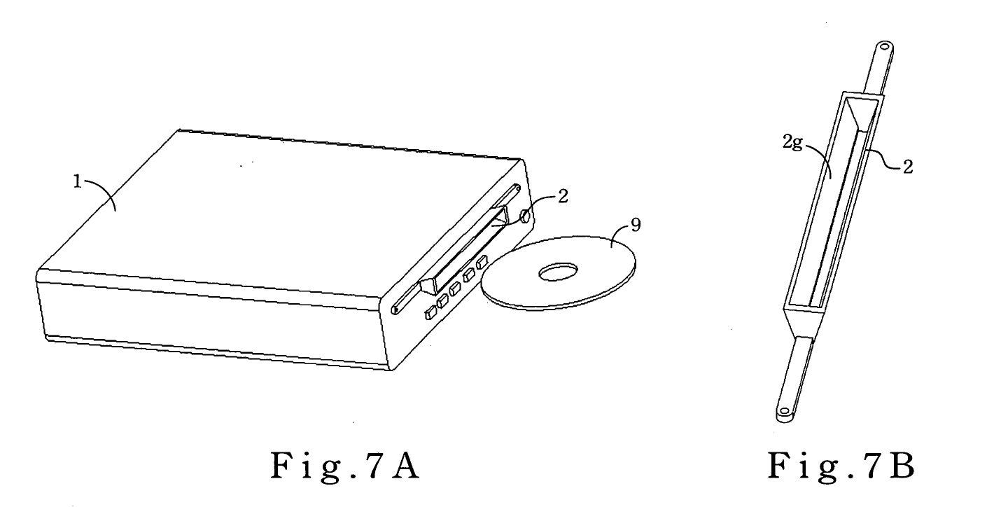

Referring to FIGS. 7A and 7B, the second preferred embodiment of a disk drive according to the present invention is shown to have a construction similar to the first preferred embodiment. The only difference resides in that the outer end of the guider wall 2g has a longitudinal length of about 8 cm smaller than that of the first preferred embodiment, since the guider wall 2g is intended for guiding a smaller optical disk 9.

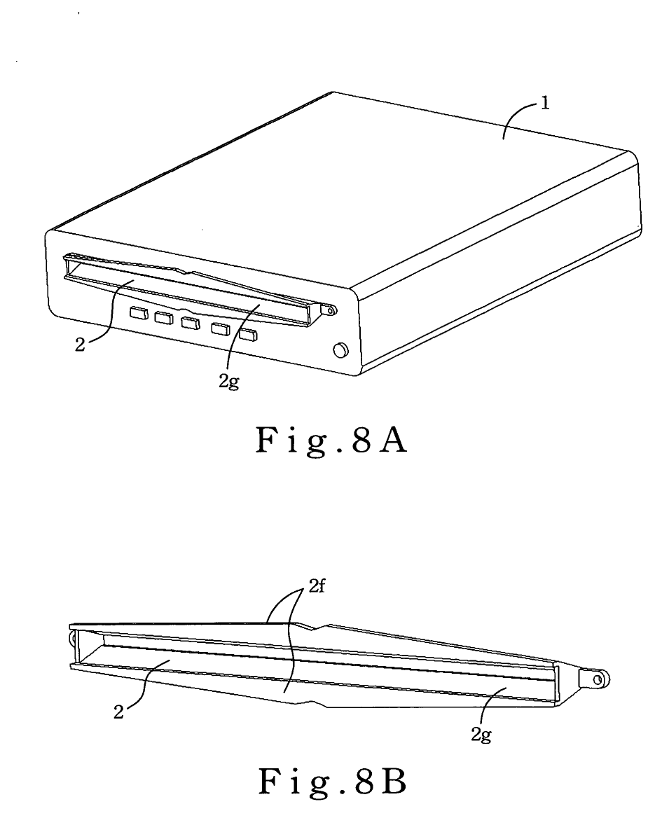

Referring to FIGS. 8A and 8B, the third preferred embodiment of a disk drive according to the present invention is shown to have a construction similar to the first preferred embodiment. The main difference resides in that the guider wall 2g further has upper and lower guiding flanges 2f extending forwardly and divergently from the top and bottom portions of the outer end, thereby widening the cross section of the outer end to further facilitate insertion of the optical disk into the casing 1.

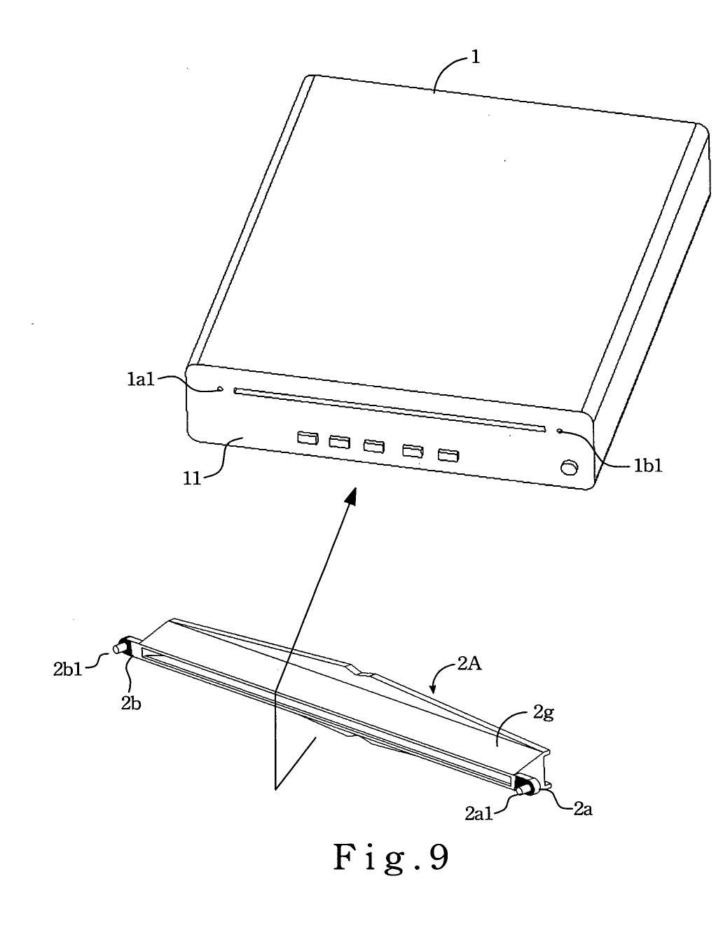

Referring to FIG. 9, the fourth preferred embodiment of a disk drive according to the present invention is shown in an exploded view, and has a construction similar to the first preferred embodiment. The main difference resides in that two mounting parts 2a, 2b project respectively and outwardly from two opposite sides of the hollow guider wall 2g. The fastening member include two engagement post 2a1, 2b1 integrally and respectively formed on the mounting parts 2a, 2b for press-fitted into the holes 1a1, 1b1 in the front wall 11 of the casing 1.

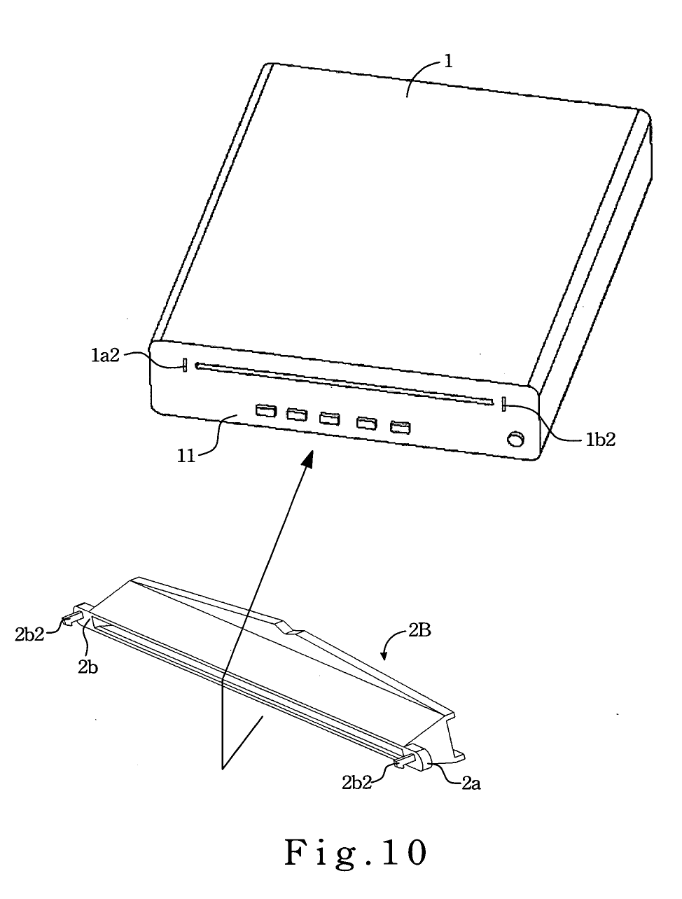

Referring to FIG. 10, the fifth preferred embodiment of a disk drive according to the present invention is shown in an exploded view, and has a construction similar to the first preferred embodiment. The main difference resides in that two mounting parts 2a, 2b project respectively and outwardly from two opposite sides of the hollow guider wall 2g. The fastening member includes two engaging hooks 2a2, 2b2 integrally and respectively formed on the mounting parts 2a, 2b of the guider wall 2g for engaging the peripheries defining the holes 1a2, 1b2 in the front wall 11 of the casing 1, thereby preventing untimely removal of the disk guider 2 from the casing 1.

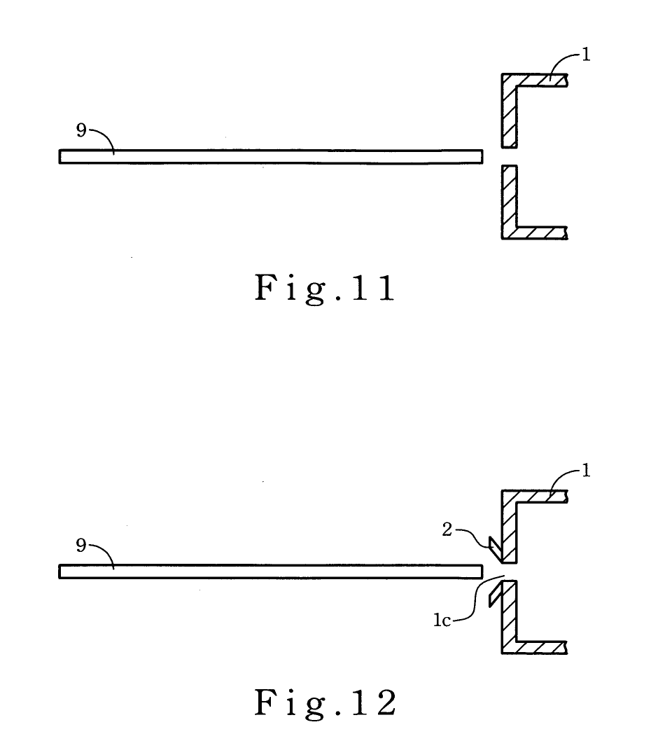

FIG. 11 is a side view, illustrating how the optical disk 9 is inserted into the casing 1 via the entrance-and-exit slot 1c of the conventional disk drive. FIG. 12 is a side view, illustrating how the optical disk 9 is inserted into the casing 1 via the disk guider 2 mounted on the front wall of the casing 1 of the disk drive according to the present invention. By comparing FIGS. 11 and 12, one can observe that in the past, great care is needed to align the disk 9 with the entrance-and-exit slot 1c prior to conducting the insertion operation. In contrast, when the disk drive of the present invention is used, little effort and care is needed to place the disk 9 within the outer opening of the disk guider 2 so as to easily align the disk 9 with the entrance-and-exit slot 1c.

With the employment of the disk guider in the disk drive according to the present invention, the disadvantage resulting from the use of the conventional disk drive can be avoided.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A disk guider for an optical disk drive that includes a front wall formed with an elongated disk entrance-and-exit slot, the disk guider comprising:
a hollow guider wall having an inner end adapted to be mounted on the front wall and defining an inner opening adapted to be aligned with and in spatial communication with the entrance-and-exit slot, and an outer end defining an outer opening which gradually and inwardly converges toward said inner end such that said outer end has a cross-section greater than that of said inner end; and
a fastening member for fastening said guider wall on the front wall.

2. The disk guider according to claim 1, further comprising two mounting parts that respectively and outwardly project from two opposite sides of said hollow guider wall.

3. The disk guider according to claim 2, wherein each of said mounting parts is formed with a through hole, said fastening member including two fastener screws extending respectively through said through holes in said mounting parts for threadedly engaging the front wall.

4. The disk guider according to claim 1, further comprising two mounting parts that respectively and outwardly project from two opposite sides of said hollow guider wall, said fastening member including two engagement posts integrally and respectively formed on said mounting parts for engaging the front wall.

5. The disk guider according to claim 1, further comprising two mounting parts that respectively and outwardly project from two opposite sides of said hollow guider wall, said fastening member including two engaging hooks integrally and respectively formed on said mounting parts for engaging the front wall.

6. An optical disk drive having a front wall formed with an entrance-and-exit slot, the disk drive comprising:
a hollow guider wall adapted to be mounted on the front wall; and
a fastening member for fastening said guider wall on the front wall.

7. The optical disk drive according to claim 6, further comprising two mounting parts that respectively and outwardly project from two opposite sides of said hollow guider wall, each of said mounting parts being formed with a through hole, said fastening member including two fastener screws extending respectively through said through holes in said mounting parts for threadedly engaging the front wall.

8. The optical disk drive according to claim 6, wherein said hollow guider wall has an inner end defining an inner opening adapted to be aligned with and in spatial communication with the entrance-and-exit slot in the front wall, and an outer end defining an outer opening which gradually and inwardly converges toward said inner end such that said outer end has a cross-section greater than that of said inner end.

9. The optical disk drive according to claim 6, further comprising two mounting parts that respectively and outwardly project from two opposite sides of said hollow guider wall, each of said mounting parts being formed with a through hole, said fastening member including two fastener screws extending respectively through said through holes in said mounting parts for threadedly engaging the front wall.

10. The optical disk drive according to claim 6, further comprising two mounting parts that respectively and outwardly project from two opposite sides of said hollow guider wall, said fastening member including two engagement posts integrally and respectively formed on said mounting parts for engaging the front wall.

11. The optical disk drive according to claim 6, further comprising two mounting parts that respectively and outwardly project from two opposite sides of said hollow guider wall, said fastening member including two engaging hooks integrally and respectively formed on said mounting parts for engaging the front wall.
